(19) United States
(12) Patent Application Publication
(10) Pub. No.: US 2012/0208160 A1
(43) Pub. Date: Aug. 16, 2012

(54) Method and system for teaching and testing radiation oncology skills

(75) Inventors: Scott Kaylor, Fremont, CA (US); Robert Amdur, Gainesville, FL (US); Arthur Boyer, Belton, TX (US)

(73) Assignee: RadOnc eLearning Center, Inc., Fremont, CA (US)

(21) Appl. No.: 12/932,044

(22) Filed: Feb. 16, 2011

(51) Int. Cl. G09B 23/28

(52) U.S. Cl. 434/262

(57) ABSTRACT

Method and system are provided to permit a user to access, via a network, a computer-implemented education module for teaching and testing radiation oncology skills. An education module may be directed to a particular skill, such as e.g., correctly identifying an anatomical region of interest in a stack of medical images. In one embodiment, education modules for teaching and testing radiation oncology skills may be made accessible to users via a portal user interface that can be rendered by a web browser application. An education module, according to one example embodiment, includes a video component for providing a video presentation describing the technique being taught, a practice module that provides an interactive practice session that can be initiated by a user after viewing the teaching video, and a test module.

### TECHNICAL FIELD

This application relates to the technical fields of software and/or hardware technology and, in one example embodiment, to system and method to provide

### BACKGROUND

Medical imaging permits viewing of the internal anatomical structure of a patient and visualizing physiological or metabolic information and is used in screening, diagnosis, and treatment of various diseases. Some well-known imaging techniques utilized in clinical medicine include X-ray and computed tomography (CT), ultrasound, ultrasonic imaging, and magnetic resonance imaging (MRI). A medical image file may conform to a standard Digital Imaging and Communications in Medicine (DICOM) format.

### BRIEF DESCRIPTION OF DRAWINGS

Embodiments of the present invention are illustrated by way of example and not limitation in the Fig. of the accompanying drawings, in which like reference numbers indicate similar elements and in which:

FIG. 1 is a diagrammatic representation of a network environment within which an example method and system for teaching and testing radiation oncology skills may be implemented;

FIG. 2 is block diagram of a system for teaching and testing radiation oncology skills, in accordance with one example embodiment;

FIG. 3 shows an example portal user interface, in accordance with an example embodiment; and

FIG. 4 shows an example practice session user interface, in accordance with an example embodiment; and

FIG. 5 is a flow chart of a computer-implemented method for teaching and testing radiation oncology skills, in accordance with an example embodiment;

FIG. 6 is a flow chart of a computer-implemented method for providing a practice session, in accordance with an example embodiment;

FIG. 7 is a flow chart of a computer-implemented method for providing a test session, in accordance with an example embodiment;

FIG. 8-16 illustrate a process to measure similarity of two contours in accordance with an example embodiment;

FIG. 17 is a diagram depicting structures in a selected axial reconstruction plane, in accordance with an example embodiment;

FIG. 18 is a diagram illustrating an outside point and an inside point with respect to a contour, in accordance with an example embodiment;

FIG. 19 is a diagram illustrating two vectors; and

FIG. 20 is a diagrammatic representation of an example machine in the form of a computer system within which a set of instructions, for causing the machine to perform any one or more of the methodologies discussed herein, may be executed.

### DETAILED DESCRIPTION

A method and system that provides tools for teaching and testing radiation oncology skills is described. In the following description, for purposes of explanation, numerous specific details are set forth in order to provide a thorough understanding of an embodiment of the present invention. It will be evident, however, to one skilled in the art that the present invention may be practiced without these specific details.

As used herein, the term “or” may be construed in either an inclusive or exclusive sense. Similarly, the term “exemplary” is construed merely to mean an example of something or an exemplar and not necessarily a preferred or ideal means of accomplishing a goal. Additionally, although various exemplary embodiments discussed below may be deployed on one or more Java-based servers and related environments, the embodiments are given merely for clarity in disclosure. Thus, any type of server environment, including various system architectures, may employ various embodiments of the application-centric resources system and method described herein and is considered as being within a scope of the present invention.

Method and system are provided to permit a user to access, via a network, a computer-implemented education module for teaching and testing radiation oncology skills. An education module may be directed to a particular skill, such as, e.g., correctly identifying an anatomical region of interest in a stack of medical images. In one embodiment, education modules for teaching and testing radiation oncology skills may be made accessible to users via a portal user interface that can be rendered by a web browser application. An education module, according to one example embodiment, includes a video component for providing a video presentation describing the technique being taught, a practice module that provides an interactive practice session that can be initiated by a user after viewing the teaching video, and a test module.

A practice module may be implemented as an interactive computer program that presents medical images on a display device and permits a user to practice drawing contours using computer graphics techniques and overlay reference contours onto the presented medical images. A user interface provided with the practice module may include visual controls that permit a user to select an anatomical region of interest, to request activating a drawing mode such that the user can use computer graphics tools to generate contours, and to request that a reference contour is overlayed onto the presented medical image to provide visual comparison between user-generated contours and reference contours.

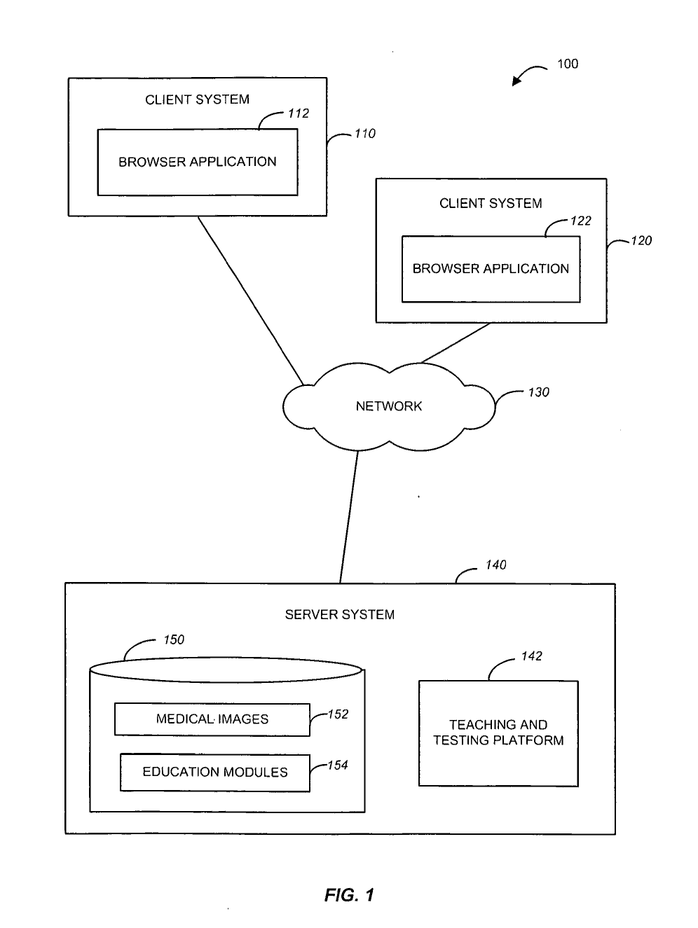

A test module, like the practice module, may be implemented as an interactive computer program. The test module may be configured to present, on a display device, medical images that the user is being tested on and to permit a user to draw contours using computer graphics techniques in response to a test assignment. The test module may be also configured to not permit a user to view reference contours; instead, the test module may utilize reference contours to calculate a quantitative value for each user-generated contour based on comparison of the user-generated contour and a reference contour and present the calculated values to the user as test results. An example web-based computing application for teaching and testing radiation oncology skills may be implemented in the context of a network environment 100 illustrated in FIG. 1.

As shown in FIG. 1, the network environment 100 may include client systems 110 and 120 and a server system 140. The server system 140, in one example embodiment, may host an on-line teaching and testing platform 142. The teaching and testing platform 142, in one example embodiment, provides a portal user interface for accessing and executing education modules that teach and test radiation oncology skills. The client systems 110 and 120 may execute respective browser applications 112 and 122 and may have access to the server system 140 and to the teaching and testing platform 142 via a communications network 130. The process of a browser application interacting with the teaching and testing platform 142 may be referred as an access session. The communications network 130 may be a public network (e.g., the Internet, a wireless network, etc.) or a private network (e.g., a local area network (LAN), a wide area network (WAN), Intranet, etc.).

As shown in FIG. 1, the teaching and testing platform 142 is connected to a storage system 150. The storage system 150 may store medical images 152, and education modules 154, as well as reference contours, user-defined contours, and annotations and comments associated with medical images. Medical images and reference contours utilized by education modules 154 may conform to Digital Imaging and Communications in Medicine (DICOM) format. An example system for teaching and testing radiation oncology skills may be viewed as encompassing the teaching and testing platform 142 together with education modules stored in the storage system 150.

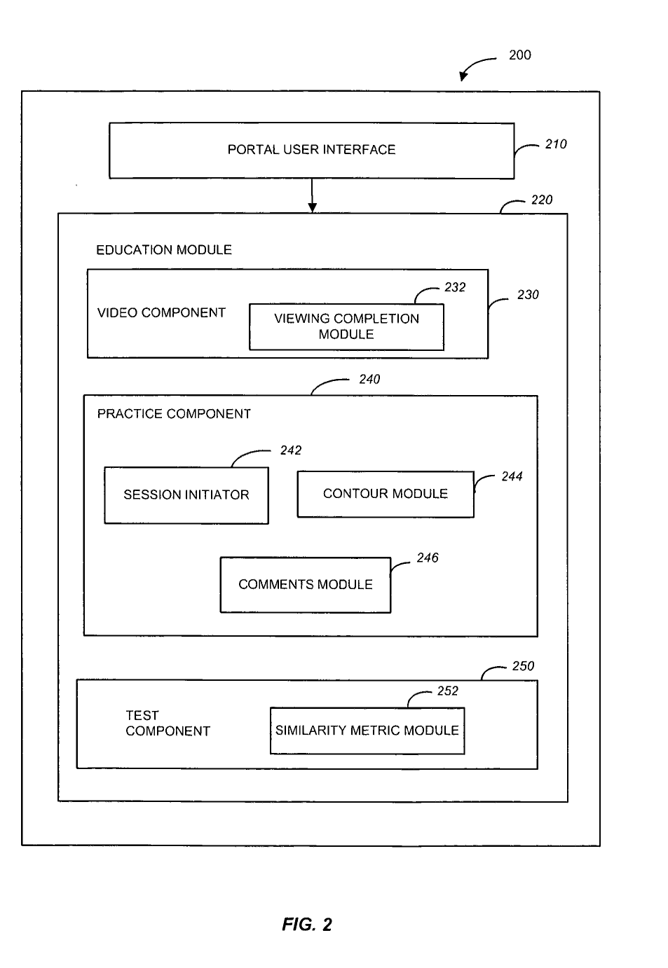

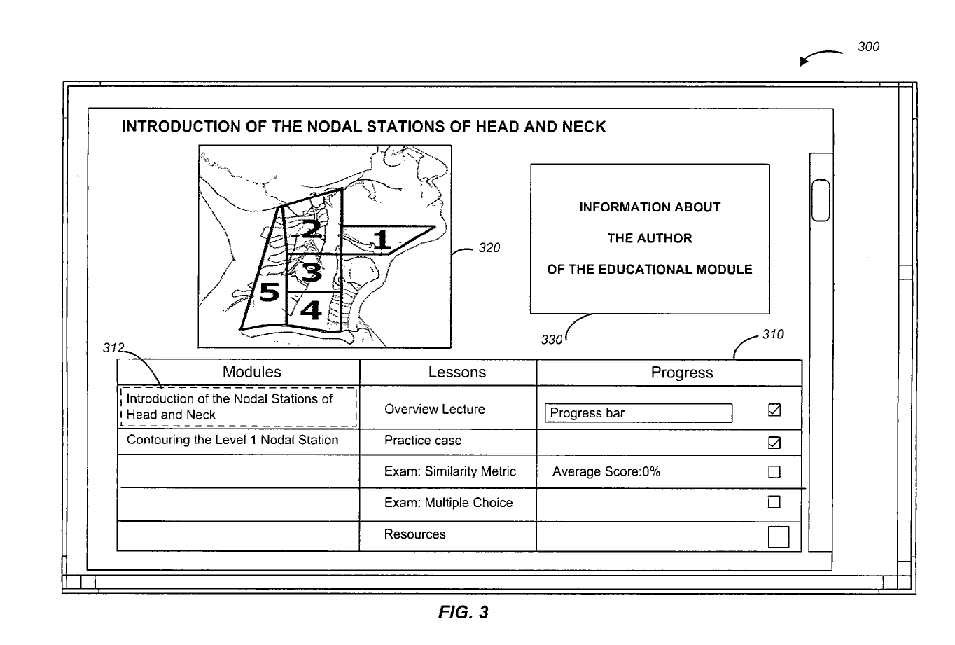

FIG. 2 illustrates a system 200 for teaching and testing radiation oncology skills, in accordance with one example embodiment. The system 200 shown in FIG. 2 comprises some components of the teaching and testing platform 142 and components of an example education module. The system 200 includes a portal user interface 210 configured to provide web-based access to one or more education modules, and an education module 220. An example portal user interface may be described with reference to FIG. 3.

A user interface 300 shown in FIG. 3 comprises an access area 310, a medical image area 320, and an author area 330. The access area 310 may be utilized in the user interface 300 for the presenting selections of education modules in the “Modules” column, presenting links to various part of the selected educational module in the “Lessons” column, and presenting visual indicators of a user's progress with respect to the use of the selected module in the “Progress” column. The selected education module may be highlighted using various computer graphics techniques. In FIG. 3, the module in area 312, titled “Introduction of the Nodal Stations of Head and Neck,” is shown as highlighted by presenting a broken-line border around the area 312. The image area 320 presents an image representing the selected education module. The author area 330 presents information about the author of the selected education module.

Returning to FIG. 2, the educational module 220 may include a video component 230 to stream an education video segment, e.g., a video segment providing an introduction to nodal stations of head and neck or demonstrating computer-aided contouring of an anatomical region. The video component 230 may be configured to present, on a display device, a video progress bar indicating the progress of the streaming of the video segment. A position of a progress indicator presented with a video progress bar indicates an approximate position of currently-streaming segment of the video within that video. For example, if a progress indicator is shown located approximately in the middle of the video progress bar, it may be inferred that about half of the associated video is yet to be streamed before reaching the end of the video. Permitting a user to drag a progress indicator along the progress bar towards the right-hand end of the progress bar may be referred to as fast forward capability of a video progress bar. The video component 230 may include a viewing completion module 232 configured to generate an indication of the completed viewing of the education video segment by a user associated with a user identification (ID) and permit skipping forward the streaming of the video (enable playing a later portion of the educational video after skipping an earlier portion of the educational video) only responsive to detecting such indication.

For example, when a user (associated with a user ID) launches an education module for the first time, a viewing completion indicator may be set to a default value indicating that the skipping forward functionality of a video progress bar is disabled during an access session associated with that user ID. When the viewing completion module 232 detects a completed viewing of the education module during an access session associated with a user ID, the viewing completion indicator may be set from the default value to a “completed view” value indicating that the skipping forward functionality is to be enabled during an access session associated with that user ID. The “completed view” value may thus be associated with a user ID may also be used by the system 200 to permit or to deny a user's request to initiate a practice session. In some embodiments, the system 200 may launch a practice session provided by the education module 220 only of the “completed view” value indicates that a viewing of the education video has been completed at least once during an access session associated with the user ID of the current access session. A practice session may be launched utilizing a practice component 240 provided in the education module 210.

The practice component 240 comprises a session initiator 242, a contour module 244, and a comments module 246. The session initiator 242 may be configured to detect a request from a user to initiate a practice session, determine whether the user completed viewing of the associated education video, and initiate a practice session only responsive to detecting a first completed viewing of the associated by the user education video. The practice component 240 may be configured to present to a user a set of practice medical images (e.g., a stack of CT images). The user may then select a region of interest (an anatomical region visible in at least some images from the set of practice medical images) and start practicing drawing contours of the selected region of interest on the practice medical images using the computer graphics tools. The practice component 240 thus allows a user to practice identifying the region of interest in the set of medical images by generating user-defined contours based on input from the user. The user-defined contours may be displayed as overlayed onto the practice medical image as the user is performing drawing operations using the practice component.

Practice medical images may be presented to a user together with explanatory annotations provided by the author of the associated education module. Furthermore, during a practice session, a user may be permitted to add comments by invoking a comments module 246 of FIG. 2. The comments module 246 may store user-generated comments for future access as associated with an identification of the user and with the practice region of interest. In some embodiments, a user may be permitted also to associate comments with a practice reference contour or a contour defined by the user. In one example embodiment, when the comments module 246 detects a request from the user to view comments associated with the practice region of interest, the comments module 246 accesses and presents the requested comments to the user. User-generated comments may be stores such that they can be made accessible to any user who accesses the education module, which may be used, in some embodiments, as collaborative space for the users. User-defined contours may also be stored for future access. The contour module 244 may store user-generated comments as associated with a medical image also associated with the identification of the user who authored the contour. The contour module 244 may be configured to detect a request from the user to view user-defined contours and present to the user only those contours from the user-defined contours that are associated with the identification of the requesting user.

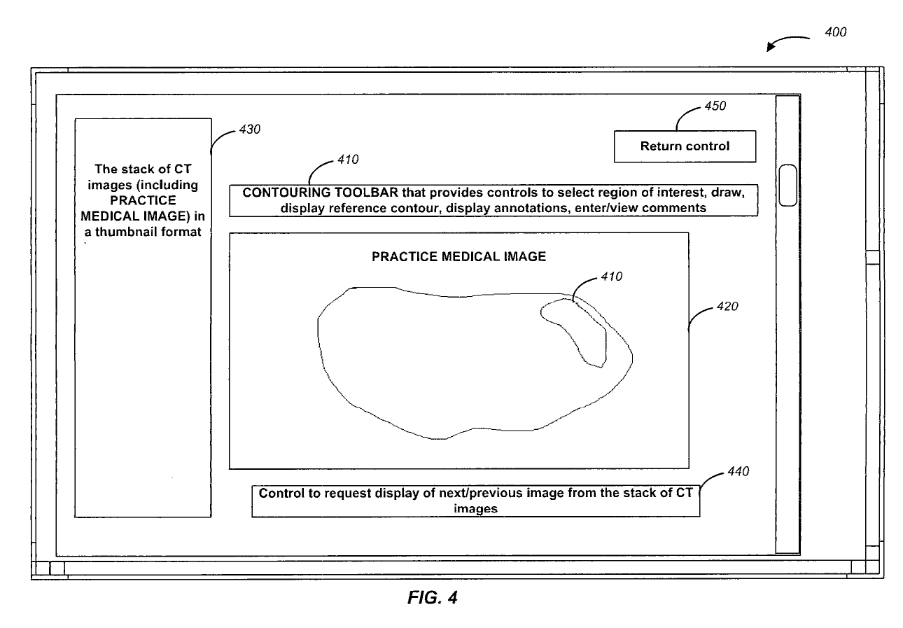

As mentioned above, the storage system 150 of FIG. 1 may store reference contours, where each reference contour represents an accurate outline of a particular region of interest that appears on a particular medical image. The practice component 240 may be configured to overlay a reference contour onto the practice medical image together with the user-defined contour, so that the user can visually evaluate the accuracy of the contour he/she just drew. A user interface provided with the practice component 240 may be described with reference to FIG. 4.

A practice session user interface 400 shown in FIG. 4 comprises a toolbar area 410, a medical image area 420, and a thumbnail area 430. The toolbar area 410 includes visual controls that permit a user to select a region of interest, to draw contours on the medical image presented in the medical image area 420, and to request that a reference contour is overlayed onto the currently-displayed medical image. As mentioned above, a practice session provided by the practice component 240 of FIG. 2 comprises presenting images from a practice set of medical images (e.g., a stack of CT images), one image at a time, where a user is attempting to draw an accurate contour of the selected region of interest on each of the presented medical images. The thumbnail area 430 may be used to present thumbnail images of the medical images in the practice set. The user interface 400 also includes a visual control 440 that can be user to navigate between the images in the practice set and a return control 450 that can be used to exit a practice session and return to the portal UI 300 shown in FIG. 3. From the portal UI 300 a user may launch a test session utilizing a test component 250 provided by the education module 220 shown in FIG. 2. In some embodiments, a practice session may be untimed, while a test session may only last a predetermined amount of time.

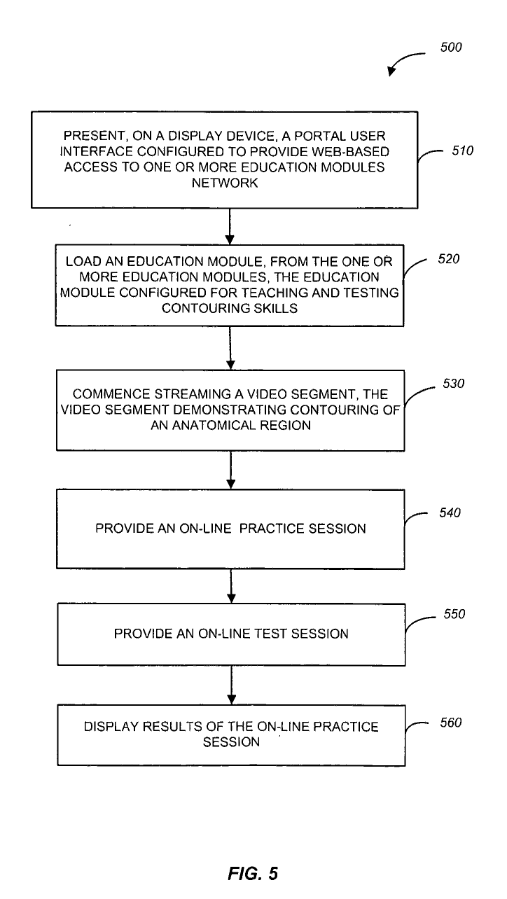

The test component 250, in one example embodiment, may be configured to present to a user a test medical image and an identification of a test region of interest in the test medical image. The user may then use the drawing tools to draw contours on the presented medical images and submit (e.g., by clicking a “submit” button on an associated user interface area) the contours for evaluation by the test component 250. The test component 250 may use a similarity metric module 252 to evaluate user-defined contours submitted by a user by comparing the test user-defined contour with a test reference contour representing the test region of interest using a similarity metric. An example metric to measure similarity of two contours is discussed further below. An example computer-implemented method for teaching and testing radiation oncology skills can be described with reference to FIG. 5.

FIG. 5 is a flow chart of a method 500 for teaching and testing radiation oncology skills using a web-based computing application, according to one example embodiment. The method 500 may be performed by processing logic that may comprise hardware (e.g., dedicated logic, programmable logic, microcode, etc.) In one example embodiment, the processing logic resides at the server system 140 of FIG. 1.

As shown in FIG. 5, the method 500 commences at operation 510, where a portal user interface configured to provide web-based access to one or more education modules is presented on a user's display device, e.g., via the browser application 112 provided at the client system 110 of FIG. 1. The portal user interface is provided by the teaching and testing platform 142 hosted at the server system 140 of FIG. 1. At operation 520, an education module, configured for teaching and testing contouring skills is loaded such that it can be interactively used via the browser application 112. At operation 530, the video component of the loaded education module commences streaming of a video segment demonstrating contouring of an anatomical region. At operation 540, the practice component of the education module commences an on-line practice session. A test session is commenced at operation 550, and the results of the test session are generated and displayed at operation 560.

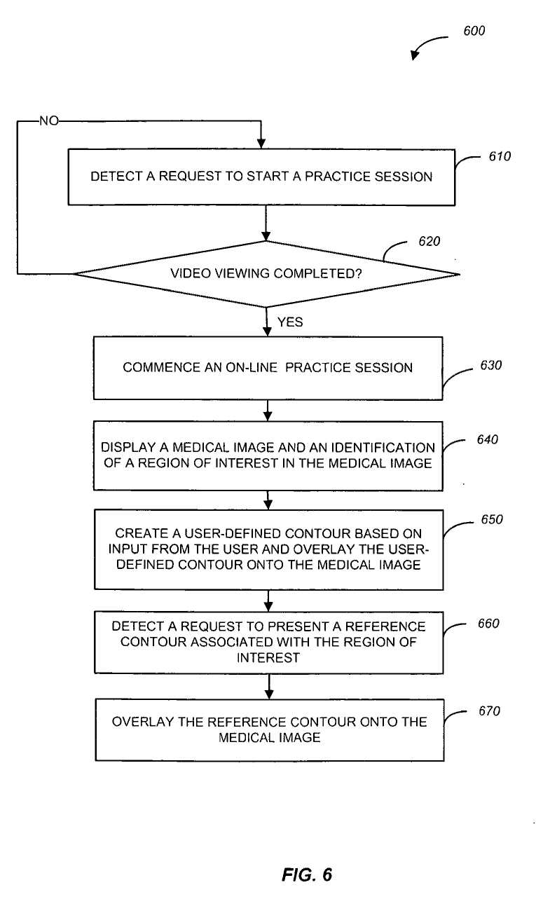

FIG. 6 is a flow chart of a method 600 for providing a practice session using a web-based computing application, according to one example embodiment. The method 600 may be performed by processing logic that may comprise hardware (e.g., dedicated logic, programmable logic, microcode, etc.) In one example embodiment, the processing logic resides at the server system 140 of FIG. 1.

As shown in FIG. 6, the method 600 commences at operation 610, where the session initiator 242 of FIG. 2 detects a request to start a practice session associated with the education module 220. An on-line practice session is commenced and a practice session user interface is rendered by the browser application 112 at operation 630 if it is determined, at operation 620, that the requesting user has completed a viewing of the education video associated with the education module 220. The determination at operation 620 may be performed by examining a “completed view” value associated with the identification of a user requesting to start a practice session. At operation 640, a medical image and an identification of a region of interest in the medical image are displayed within the practice session user interface. At operation 650, the practice component 240 of FIG. 2 creates a practice user-defined contour based on input from the user and overlays the practice user-defined contour onto the respective practice medical image.

As described above, a user may compare the contour he/she drew with a pre-stored reference contour that represents an accurate outline of the region of interest in the medical image. At operation 660, the practice component 240 detects a request to present a reference contour associate with the area of interest and the medical image. A visual control for requesting the displaying of a reference contour may be provided in the contouring toolbar area 410 of the practice session user interface shown in FIG. 4. At operation 670, the requested reference contour is overlayed onto the medical image to provide the user with visual comparison of his practice contour and the accurate version of a contour.

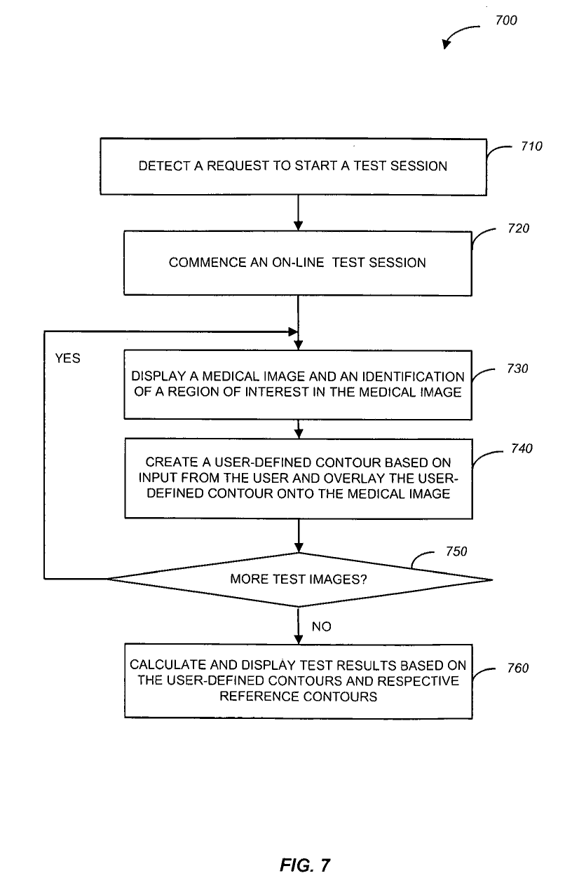

FIG. 7 is a flow chart of a computer-implemented method 700 for providing a web-based test session utilizing an education module (e.g., the education module 220 shown in FIG. 2), in accordance with an example embodiment. The method 700 may be performed by processing logic that may comprise hardware (e.g., dedicated logic, programmable logic, microcode, etc.) In one example embodiment, the processing logic resides at the server system 140 of FIG. 1.

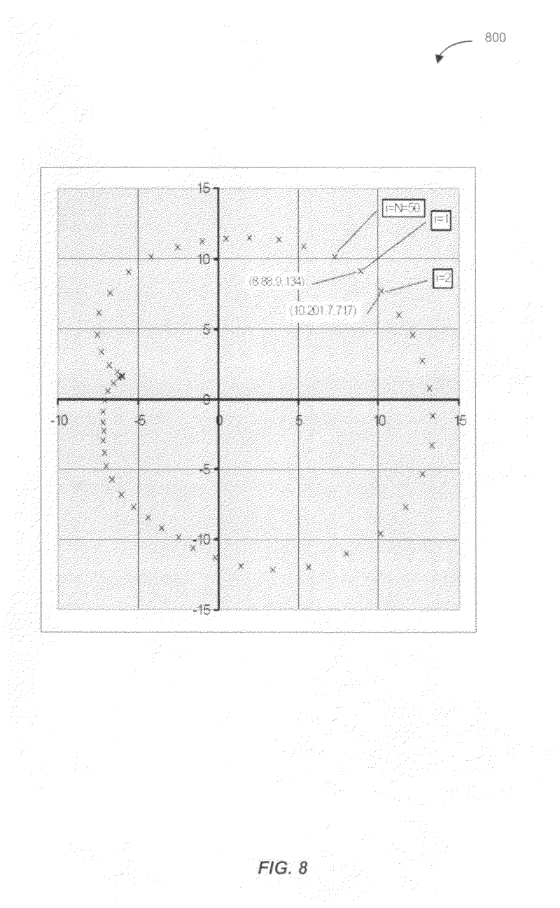

As shown in FIG. 7, the method 700 commences at operation 710, where a request to start a test session is detected. In response to the request, an on-line test session is commenced at operation 720. A test session, in one example embodiment, comprises displaying, on the display device, a test medical image and an identification of a test region of interest in the test medical image (operation 730), creating a test user-defined contour based on input from the user and overlaying the test user-defined contour onto the practice medical image (operation 740). As mentioned above, a test session may require that a user identifies, by drawing a contour, a particular anatomical area of interest that is visible in at least some of the images from a set of medical images used for testing radiation oncology skills. The operations 730 and 740 are performed for each medical image from the set (operation 750), as long as user input is provided using a drawing tool of the test user interface associated with the test component 250 of FIG. 2. At operation 760, test results are calculated by comparing the test user-defined contours with reference contours representing the test region of interest using a similarity metric and displayed on the user's display device. A process that may be utilized to measure similarity of two contours in accordance with an example embodiment may be described with reference to FIG. 8-16.

In one embodiment, contours are defined by a closed sequence of discrete points in an order specified by integers i, where i=1, 2, 3, . . . N. Each point is defined by a Cartesian coordinate pair, xi, yi, as shown in FIG. 8. This representation in FIG. 8 of a contour is called a polygon. The points that define the polygon are called vertices. The sequence starts with the vertex whose index is i=1. The values used in this example are shown in Table 1 below.

TABLE 1
x1 = 8.88
y1 = 9.134
x2 = 10.201
y2 = 7.717

The polygon is formed by drawing lines from one vertex to the next. The polygon is closed by drawing a line from the Nth vertex to the 1st vertex. This polygon is drawn in a single plane. A stack of polygons in sequential planes form what is called a wire-frame representation of a solid structure. A third coordinate is added to the definition of each vertex, xi, yi, zi. The third number, zi, gives the location of each plane. Frequently the planes are equally spaced so that the sequence of zi increases by the same increment from one plane to the next. For the entire wire frame representation, the sets of ordered sequences of vertex coordinates taken together make up the “structure set” that represents the three-dimensional object.

In radiotherapy treatment planning, computer software provides means to draw polygons in sequential planes displayed as overlays over CT scans or MRI scans. This feature allows radiation oncologists to create wire-frames that correspond to anatomical organs and anatomical features important to the development of the treatment plan. Drawing these polygons has become known as “contouring.” When any two persons contour the same object, there are differences between the two contours. Some of these differences have to do with the shape of the contours. Some have only to do with the sequence by which the contour was drawn. The purpose of this algorithm is to provide a measure of the differences between two contours that have to do with the shape. The algorithm may be designed to be insensitive to differences between the stored sequence of vertices that have only to do with the order and manner in which the contour was drawn. Suppose we are comparing a contour drawn by a Student who is learning contouring from a Mentor. The Mentor might have drawn the contour moving clockwise from an initial starting point on the right side of the contour and in so doing create a sequence that is 32 vertices long. Suppose a Student attempts to contour the same anatomical structure and is able to trace along exactly the same shape as the Mentor. But suppose the student starts at the bottom left of the contour and traces counter-clockwise picking only 28 points for the vertices. In general, the student will not pick vertices that correspond to those chosen by the mentor, even though the Student's vertices fall along exactly the same curve as those defined by the Mentor. Given the digitized and stored vertices, an example algorithm for comparing the two tracings may be designed as follows. First the algorithm, in one embodiment, resamples each contour using the same number of vertices when sampling both the Mentor's contour and the Student's contour. Secondly the algorithm reorders the Student sequence such that the first vertex in the Student sequence corresponds as nearly as possible to the first vertex in the Mentor's sequence. Thirdly, the algorithm determines the order in which the Student traced the contour from the first point. If the order is the same as that of the Mentor polygon, then nothing further must be done. However, if the algorithm determines that the Student drew a contour in the opposite sense as the Mentor, the algorithm inverts the Student sequence so that it runs in the same direction as the Mentor sequence. Once the sequences are resampled and reodered, they will represent the contour shape and position with the same number of vertices in the same order space in the same increments. Then the differences between the sequences can be computed using computed metrics such as the distance between the centroids (or centers of gravity) of the two contours as well as the sum of the root mean square differences between corresponding vertices. If the shapes of the two contours are very similar, the distances will be small. If the shapes are dissimilar, the distances between corresponding points will be great.

### Resampling

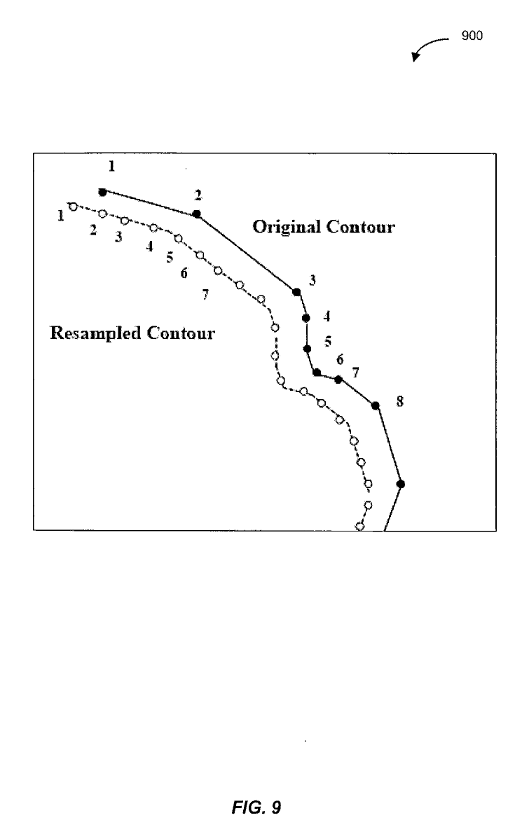

Since two digitized contours will be defined by vertices at irregular intervals, the contours are resampled. In order to compare two arrays, each array must be resampled at corresponding discrete points at the same regular intervals. Shown in FIG. 9, a portion of the perimeter around a contour is shown twice. The first presentation to the right is the Original Contour defined by vertices at irregular intervals. The second presentation, displaced slightly from the Original Contour, is the Resampled Contour defined by vertices at regular intervals.

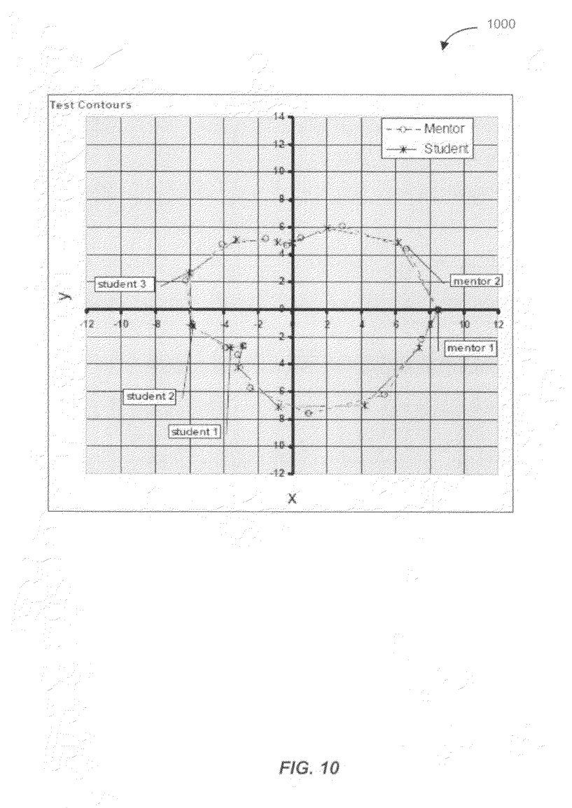

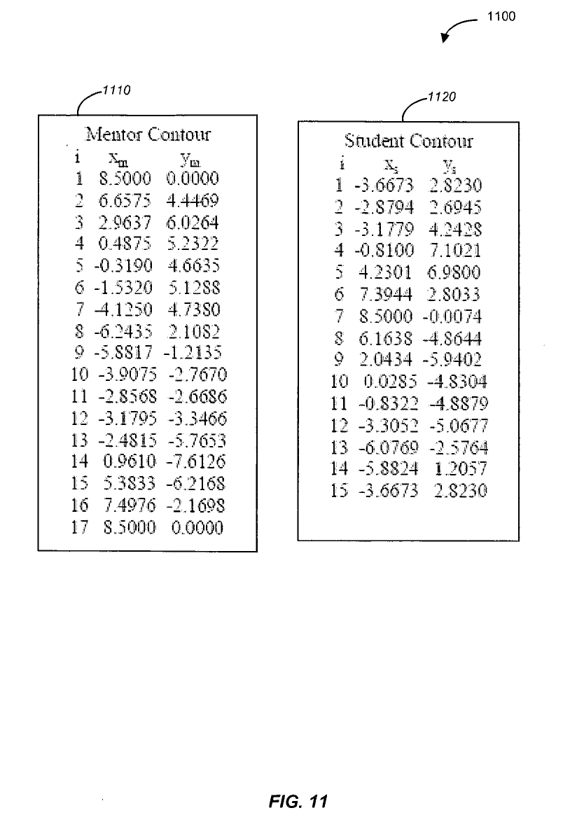

Now turning to FIG. 10, the vertex coordinates represented by diamond shapes are drawn by a Mentor who started at the right side of the structure and picked contour points moving counter-clockwise around the structure. The vertex coordinates represented by stars ( ) were drawn by a Student who started on the left side of the structure and moved clockwise around the structure. The Mentor and Student did not pick vertices at the same locations and picked different numbers of vertices. The polygons appear to have about the same shape when plotted on a Cartesian coordinate system, but the sequences of vertices look very different when examined numerically as shown in FIG. 11. The subscript m stands for Mentor and the subscript s stands for Student. The Mentor contour values are shown in block 1110 and the Student contour values are shown in block 1120. Since a computer algorithm can only examine sequences of numbers, these sequences is processed before the similarity of the shapes they represent can be evaluated numerically.

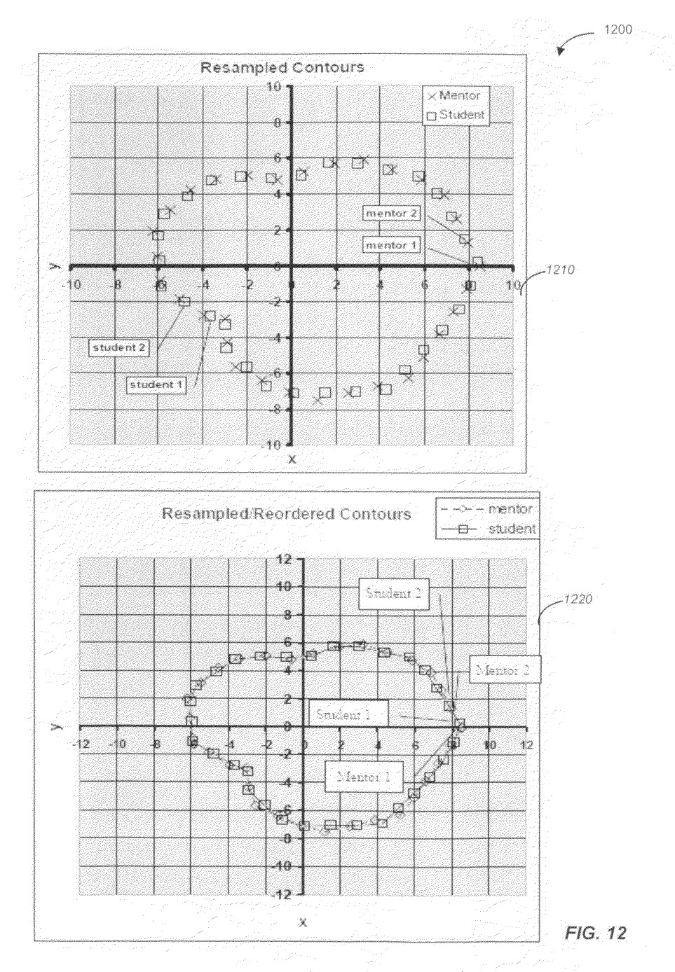

In one example embodiment, the contours are processed by first resampling the sequences such that we end up with two lists of vertex coordinates, xms(i), yms(i) for the Mentor and xss(i), yss(i) for the Student, that are equally spaced around the perimeters of the contour and have the same number of entries. The second s in the subscripts stands for “sampled.” The previous Mentor and Student contours processed in this fashion result in block 1210 of FIG. 12. The number of vertex coordinates are equal and are each equally spaced around the structure shape. Since the two contours were drawn pretty nearly the same to begin with, the perimeters are about equal and the differences in vertex locations reflect the original differences between the Student and the Mentor. However, the sequences still begin with different vertices and run in opposite directions. The next step is to reorder the Student contour vertex coordinates such that they start at the same relative vertex as the Mentor and run in the same direction. This aligns the sequence of vertex coordinates in literally a comparable manner. Now the differences between the ordered pairs of vertex coordinates reflects the differences in shapes chosen by the Mentor and the Student and is independent of the Student's starting point and direction of contouring relative to the starting point and direction of contouring of the Mentor, as is shown in block 1220 of FIG. 12. Calculations of the cumulative differences between corresponding pairs of the vertex coordinate points can be used to calculate numerical measures of the differences between the two contours.

Let us now consider how these processing steps can be accomplished algorithmically. The total perimeters pₜₒₜ around an original contour defined by vertices [xₘ(i), yₘ(i)] and the perimeter qₜₒₜ around the resampled contour defined by vertices [xₘₛ(i), yₘₛ(i)] are as shown in Table 2 below.

TABLE 2

pₜₒₜ = i [̅x̅ₘ̅(̅i̅ +̅ 1̅)̅ −̅ x̅ₘ̅(̅i̅)̅]̅²̅ [symbol] [̅y̅ₘ̅(̅i̅ +̅ 1̅)̅ −̅ y̅ₘ̅(̅i̅)̅]̅²̅[̅x̅ₘ̅(̅i̅ +̅ 1̅)̅ −̅ x̅ₘ̅(̅i̅)̅]̅²̅ [symbol] [̅y̅ₘ̅(̅i̅ +̅ 1̅)̅ −̅ y̅ₘ̅(̅i̅)̅]̅²̅[̅x̅ₘ̅(̅i̅ +̅ 1̅)̅ −̅ x̅ₘ̅(̅i̅)̅]̅²̅ [symbol] [̅y̅ₘ̅(̅i̅ +̅ 1̅)̅ −̅ y̅ₘ̅(̅i̅)̅]̅²̅[̅x̅ₘ̅(̅i̅ +̅ 1̅)̅ −̅ x̅ₘ̅(̅i̅)̅]̅²̅ [symbol] [̅y̅ₘ̅(̅i̅ +̅ 1̅)̅ −̅ y̅ₘ̅(̅i̅)̅]̅²̅
i = 1, 2, . . . N
qₜₒₜ = i [̅x̅ₘ̅ₛ̅(̅i̅ +̅ 1̅)̅ −̅ x̅ₘ̅ₛ̅(̅i̅)̅]̅²̅ +̅ [̅y̅ [symbol] ₘ̅(̅i̅ +̅ 1̅)̅ −̅ y̅ₘ̅ₛ̅(̅i̅)̅]̅²̅[̅x̅ₘ̅ₛ̅(̅i̅ +̅ 1̅)̅ −̅ x̅ₘ̅ₛ̅(̅i̅)̅]̅²̅ +̅ [̅y̅ [symbol] ₘ̅(̅i̅ +̅ 1̅)̅ −̅ y̅ₘ̅ₛ̅(̅i̅)̅]̅²̅[̅x̅ₘ̅ₛ̅(̅i̅ +̅ 1̅)̅ −̅ x̅ₘ̅ₛ̅(̅i̅)̅]̅²̅ +̅ [̅y̅ [symbol] ₘ̅(̅i̅ +̅ 1̅)̅ −̅ y̅ₘ̅ₛ̅(̅i̅)̅]̅²̅[̅x̅ₘ̅ₛ̅(̅i̅ +̅ 1̅)̅ −̅ x̅ₘ̅ₛ̅(̅i̅)̅]̅²̅ +̅ [̅y̅ [symbol] ₘ̅(̅i̅ +̅ 1̅)̅ −̅ y̅ₘ̅ₛ̅(̅i̅)̅]̅²̅
j = 1, 2, . . . Nsamp

[symbol]

indicates data missing or illegible when filed

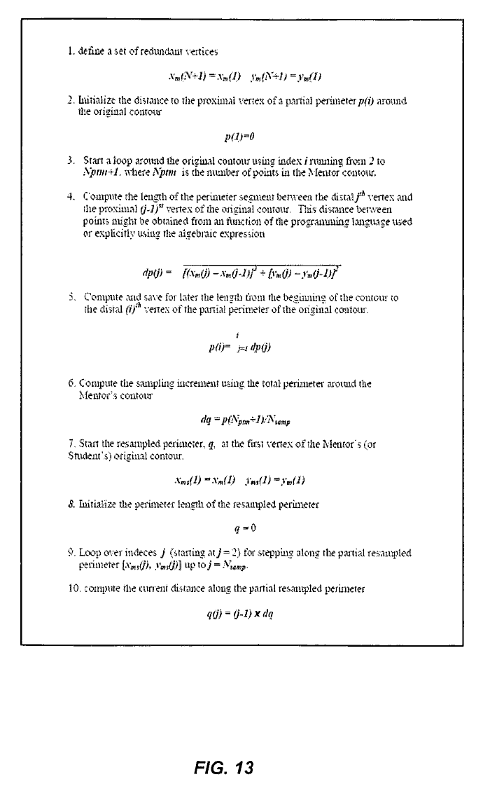

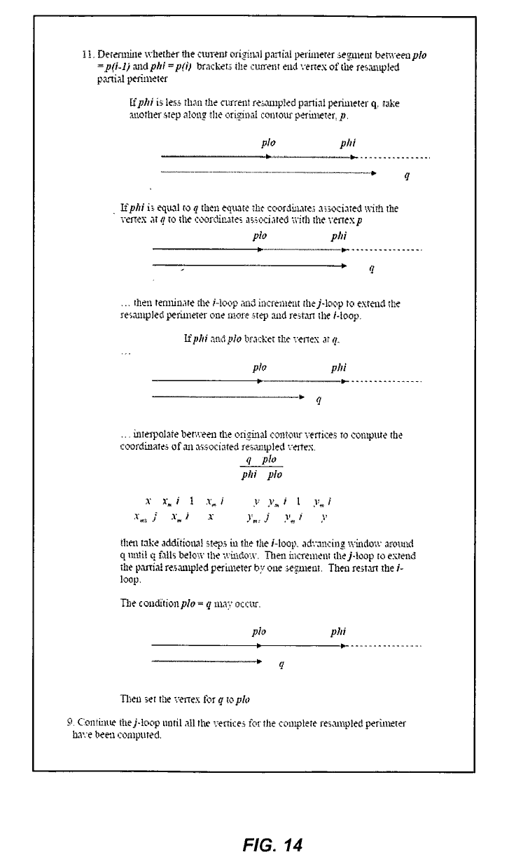

In Table 2 above, N is the total number of vertices in the original contour and Nₛₐₘₚ is the number of vertices in the resampled contour. In the sample program, N=Nₚₜₘ is the number of points in the Mentor's contour and N=Nₚₜₛ is the number of points in the Student's contour. In the algorithm, qₜₒₜ is not calculated, but is defined here to give the context in which increments dq along the resampled perimeter are defined. The number of samples Nₛₐₘₚ is hard-coded into the algorithm (in the example algorithm it is Nₛₐₘₚ=500) and is chosen to be a number that can be expected to be greater than the number of vertices that the Mentor or Student will use. The sums above assume that the contours are closed by vertices xₘ(N+1)=xₘ(1) and yₘ(N+1)=yₘ(1). In order for the total perimeter of the resampled contour to be equal to the total perimeter of the original contour, define the increment, at which the vertices are to be put in the resampled array, dq=pₜₒₜ/Nₛₐₘₚ, where Nₛₐₘₚ is the number of resampled points for the resampled contour. In the example algorithm, the number of points in the Mentor contour and the number of points in the Student contour are free input parameters and would depend on how the Mentor and Student draw their respective contours. A pseudo-code algorithm for the resampling is as shown in FIGS. 13 and 14.

By setting Nₛₐₘₚ to a high value, one intends to obtain several resampled vertices between each original vertex in the contour. By oversampling the original contour one avoids aliasing errors due to having missed one of the originally selected vertices.

This resampling is carried out for both the Mentor contour, to obtain [xₘₛ(i), yₘₛ(i)], and the Student contour, to obtain [xₛₛ(i), yₛₛ(i)].

Further operations are then carried out on the resampled contours. The goal is to reorder the Student vertex list such that its entries correspond to the Mentor vertex list entries. To determine what order is most likely to achieve this correspondence, the square root of the sum of the differences between the vertices is computed, the rₘₛ value. This value is computed for each possible order of the resampled Student vertex list. The reordering that produces the lowest rₘₛ value is assumed to be the order that achieves the correspondence between vertices.

A double loop is used to compute a root-mean-square (rms) comparison of differences between pairs of vertices along the two contours according to the equations shown in Table 3 below.

TABLE 3

rmsₚ(j) = i̅[̅(̅x̅ₘ̅ₛ̅(̅i̅)̅ −̅ X̅ₛ̅ₛ̅(̅i̅p̅<̅i̅,̅ j̅>̅)̅)̅²̅ [symbol] (̅y̅ₘ̅ₛ̅(̅i̅)̅ −̅ y̅ₛ̅ₛ̅(̅i̅p̅<̅i̅,̅ j̅>̅)̅)̅²̅]̅i̅[̅(̅x̅ₘ̅ₛ̅(̅i̅)̅ −̅ X̅ₛ̅ₛ̅(̅i̅p̅<̅i̅,̅ j̅>̅)̅)̅²̅ [symbol] (̅y̅ₘ̅ₛ̅(̅i̅)̅ −̅ y̅ₛ̅ₛ̅(̅i̅p̅<̅i̅,̅ j̅>̅)̅)̅²̅]̅i̅[̅(̅x̅ₘ̅ₛ̅(̅i̅)̅ −̅ X̅ₛ̅ₛ̅(̅i̅p̅<̅i̅,̅ j̅>̅)̅)̅²̅ [symbol] (̅y̅ₘ̅ₛ̅(̅i̅)̅ −̅ y̅ₛ̅ₛ̅(̅i̅p̅<̅i̅,̅ j̅>̅)̅)̅²̅]̅i̅[̅(̅x̅ₘ̅ₛ̅(̅i̅)̅ −̅ X̅ₛ̅ₛ̅(̅i̅p̅<̅i̅,̅ j̅>̅)̅)̅²̅ [symbol] (̅y̅ₘ̅ₛ̅(̅i̅)̅ −̅ y̅ₛ̅ₛ̅(̅i̅p̅<̅i̅,̅ j̅>̅)̅)̅²̅]̅
rmsₙ(j) = i[(xₘₛ(i) − Xₛₛ(in<i, j>))² [symbol] (yₘₛ(i) − yₛₛ(in<i, j>))²]

[symbol]

indicates data missing or illegible when filed

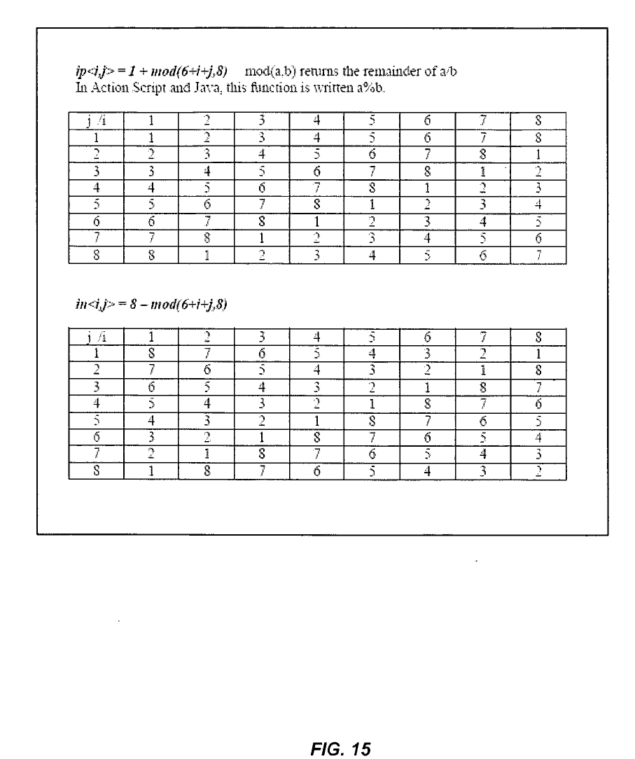

The argument in <i,j> pairs the vertices such that the starting point of the Student contour rotates clockwise (negative rotation), and iₚ<i,j> pairs the vertices such that the starting point of the Student contour rotates counter-clockwise (positive rotation), around the Mentor contour. Shown in FIG. 15 are tables created by the two integer functions shown in Table 3 above for a sequence of 8 vertices.

Determine the minimum rms value, rmsₚ(jₚ), and the rotation offset jₚ for positive rotation; and the minimum rms value, rmsₙ(jₙ), and the rotation offset jₙ for negative rotation. The lower value between rmsₚ(jₚ) and rmsn(jₙ) identifies the direction that the Student contour was digitized relative to the Mentor contour. The indices jₚ or jₙ give the offset between the Mentor contour sequence and the Student contour sequence. These steps assume that the contours are relatively similar. Any one vertex in the Student contour could be close to the Mentor's first vertex without in fact being the Student's first vertex point. But using the rms sum for all offsets of the Student contour and both directions of comparison, one uses the entire sequence to determine which order is most similar to the Mentor's order and direction.

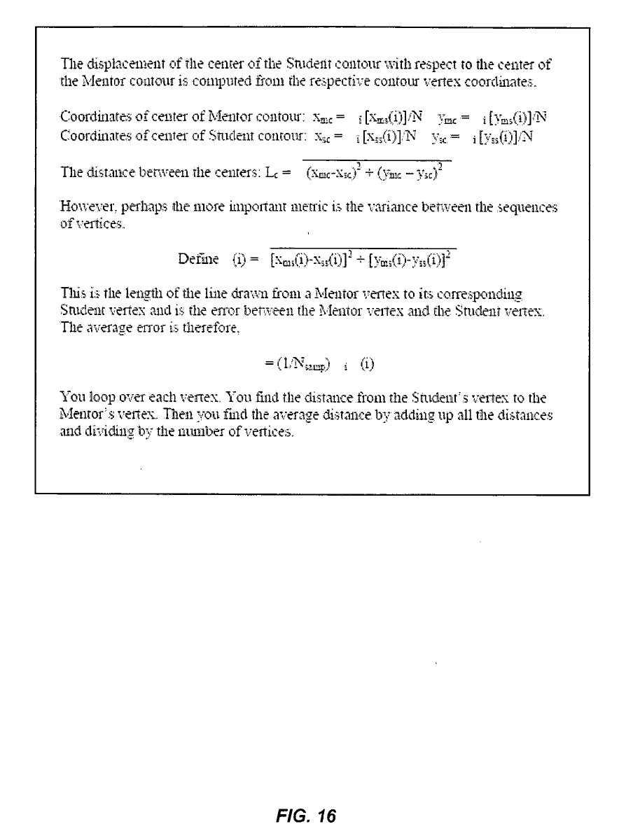

Reorder the Student contour so that the index value jₚ or jₙ is the first vertex in the Student sequence and the other vertices are ordered in the same order as the Mentor contour. Now a metric can be computed to compare the two contours, as shown in FIG. 16.

A system for teaching and testing radiation oncology skills may utilize various further similarity metrics to compare student contours against reference contours. These further similarity metrics can be used independently, or in combination with one another. Four example similarity metrics are described below. These similarity metrics are labeled Point Domain, Line Domain, Plane Domain, and Volume Domain respectively. The test component 250 of FIG. 2 may be configured to compute metrics that score a student's response in one or more of these test modes. An auxiliary tool of the similarity metric module 252 of FIG. 2 may be configured to provide instructors with means to collect the metrics at the conclusion of a test in order to analyze the performance of students who used the education module.

### Point Domain

In one embodiment, the similarity metric module 252 may be configured to measure the distance, Δr, e.g., in units of centimetres between a named point selected with a mouse-driven cursor by the student on an axial reconstruction within a CT study and the point of that name previously defined by a mentor using a mouse-driven cursor. Part of the extension will be a sequence by which the mentor names and points to the points. The list of points will be available to the student in the Point Domain test sequence as a drop-down menu. The point selection error, Δr, will be calculated from three components: Δx—the horizontal distance between the student's point and the mentor's point, Δy—the vertical distance between the student's point and the mentor's point, and Δz—the distance between the axial reconstruction plane in which the student has selected a point and the axial reconstruction plane in which the mentor placed the point, as shown in Table 4 below.

TABLE 4
Δr = \sqrt{(Δx)² + (Δy)² + (Δz)²}

An auxiliary tool can be provided with the similarity metric module 252 that will allow an instructor to harvest the point selection errors of all students in a class. The auxiliary tool will allow the instructor to compute and plot the frequency distribution f(Δr) as a histogram and to compute the mean, mode and standard distribution of the class sample. The tool will allow the instructor to save the statistics for a session within a given with a mouse-driven cursor class. This tool may be supplied as an Excel spreadsheet if sufficient means are provided to conveniently harvest the point selection errors from the class.

### Line Domain

In another embodiment, the similarity metric module 252 provides a sufficient computation of the mean error between a student contour on a given axial reconstruction plane and the mentor contour on that plane. Contours will be displayed graphically together with colors and/or line types identifying the student contour and the mentor contour. This metric re-computes the vertices of the two contours to be compared to provide a regularly spaced sequence of pairs of corresponding vertices along each contour. The distances between corresponding pairs of vertices are computed and used to create a metric that measures the similarity of the two contours. Two situations need to be discussed further: planes for which the mentor draws a contour and the student doses not, and planes for which the mentor supplies no contour and the student places a contour. In such cases statistics for a single plane are indeterminate. Some agreement may be provided on how to handle these cases in averaging over the volume of the structure. A reference contour is provided in these exercises. For a given class, the Instructor's contour is specified. This may in fact be a previously defined consensus contour. In one embodiment, an auxiliary tool can be provided that will allow the instructor to harvest all the students' similarity metrics and to compute and plot the frequency distributions, means, and standard deviations computed over the class size for every plane contoured as well as the global mean and standard deviation for all planes computed over the class size. Repeated exercises can be collected to allow a comparison before and after an explanation, as well to have the possibility to show the global outcome of selected classroom exercises. In addition graphics will be provided that allow the instructor to plot and display to the class all the contours drawn for a given structure in a given plane along with the mentor's contour in a different color or line type.

### Area Domain

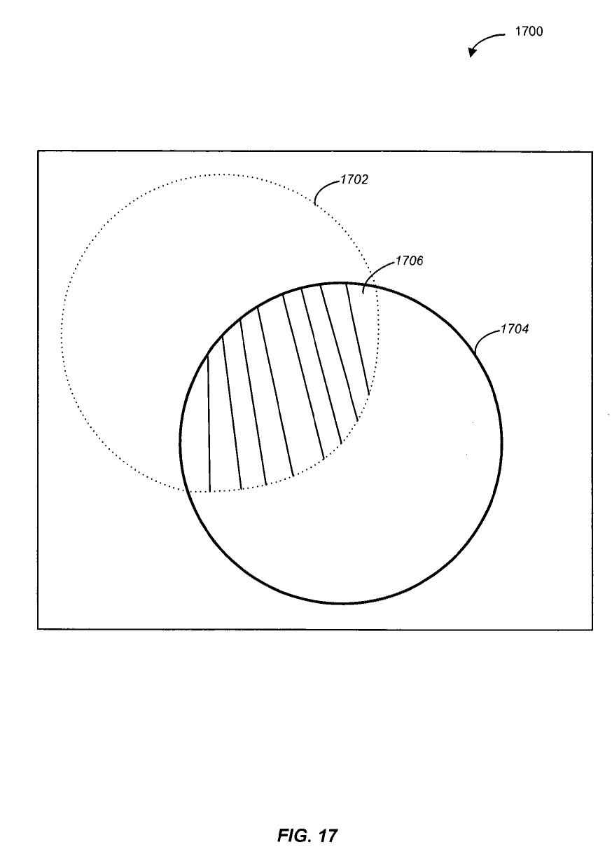

In yet another embodiment, the similarity metric module 252 can be extended to include an Area Domain metric and statistics expressed as areas in units of square centimeters. FIG. 17 is a diagram 1700 depicting structures (e.g., contours) in a selected axial reconstruction plane. A mentor structure area 1702 may be called the Area of Consensus (AC). A student structure area 1704 may be called the Delineated Area (DA). Area 1706 may be called the Area of Intersection (AI). The area 1706 is the area of overlap of the mentor structure 1702 with the student structure 1704. The area of the mentor's structure (the Area of Consensus 1702) exclusive of the Area of Intersection 1706 is the area that the student failed to include in their Delineated Area. The area of the student's structure (the Delineated Area 1704) exclusive of the Area of Intersection 1706 is the area of the student structure that lies outside the mentor's structure. In one embodiment, graphics may be provided that allow a student utilizing an educational module or a mentor within the Auxiliary Program to display the AC, DA, and AI for a selected student, for a selected contour, in a selected plane. In one embodiment, the Auxiliary Program may be configured to count the pixels in these areas in each reconstruction plane that contains both a mentor contour and a student contour for a selected structure. A Dice Similarity Metric (DSM) may be computed in each plane, in which a student attempts to create a contour for which there is a consensus contour, using the equation shown in Table 5 below.

TABLE 5
$DSC = 2 \times \frac{AI}{AC + DA}$

An example Auxiliary Program may be configured to provide options, by which an instructor can harvest these numbers from students using the system. The instructor's software will compute the average and standard deviation of the DSC for all planes for each student and then compute a global average and standard deviation across the data collected from all students in the class.

### Volume Domain

In yet another embodiment, the similarity metric module 252 can be extended to compute statistics for volumes. This uses the same enumeration of voxels in each reconstruction plane as the Area Domain but gives total volumes in cubic centimeters for the three volume Types. The Type 1 volume is the Volume of Intersection (VI) that corresponds to the area 1706 of FIG. 17. The Type 2 volume is the Volume of Consensus (VC) that corresponds to the area 1702 of FIG. 17. The Type 3 volume is the Delineated Volume (DV) that corresponds to the area 1704 of FIG. 17. A Concondance Index (CI) may be computed using the equation shown in Table 6 below.

TABLE 6
$CI = \frac{VI}{VC} \times 100 \%$

A complementary Discordance Index (DI) may be computed using the equation shown in Table 7 below.

TABLE 7
$DI = ( 1 - \frac{VI}{DV} ) \times 100 \%$

Computer-implemented means may be provided to harvest these numbers in the course of utilizing the system for teaching and testing radiation oncology skills, so that the instructor can construct histogram distributions of the CI and DI and tabulate the means and standard deviations for a given class (for a given set of users that completed the test session of an education module).

### Calculating the Area of a Region Defined by Multiple Contours

An example method for calculating the area of a region defined by multiple contours is explained below with reference to steps 1 through 4.

### Step 1—Compute the Volume

The volume of a structure (Vs) that is defined by a series of two-dimensional regions can thus be defined by equation shown in Table 8 below.

TABLE 8
${V}_{s} = {\sum }_{i} {A}_{i} \times {T}_{i} ,$
where Aᵢ is the area of a structure and Tᵢ denotes the thickness of reconstruction slice i.

### Step 2—Compute the Area of a Contour

A contour is a collection of ordered vertices Π{p(x, y)}, where p represents a vertex defined by two coordinates (x and y). The area enclosed by a closed contour can be computed as shown in Table 9 below.

TABLE 9
$A = \vert {\sum }_{i = 1}^{N} ( {x}_{i} \times {y}_{i + 1} - {x}_{i + 1} \times {y}_{i} ) \vert \text{/} 2 ,$
where N is the number of vertices in an open-end (the last vertex is not a replica of the first convex) contour, p(x_{N+1}, y_{N+1}) = p(x₁, y₁).

### Step 3—Construct Segmentation Matrix

Using one of several methods, a three-dimensional segmentation matrix will be constructed for each structure. The segmentation matrix algorithm uses the vertices that define the outlines of a structure in axial reconstruction planes. Each slice of the segmentation matrix directly maps to the corresponding axial image on which contours were drawn. Each segmented structure is represented in one bit plane. If the pixel is inside a contour, the bit at the pixel address in the segmentation matrix is set 1 and 0 otherwise. For example, the mentor's segmented contours are in bit plane 1 and the first student's contours are in bit plane 2, the second student's contour are in bit plane 3 and so on. Boolean operations such as AND, OR, and XOR can then be performed on bit planes to find out AI, AC and DA in area domain or VI, VC and DV in volume domain, as stated above.

### Step 4—Determine Whether a Point Lies Inside or Outside a Contour

One of the solutions for determining whether a point lies inside or outside a contour (which may be viewed as a polygon) is to compute the sum of the angles made between a test point and each pair of points making up the polygon. If this sum is 2π then the point is an interior point; if 0 then the point is an exterior point. This also works for polygons with holes given that the polygon is defined with a path made up of coincident edges into and out of the hole as is common practice in many automated design packages.

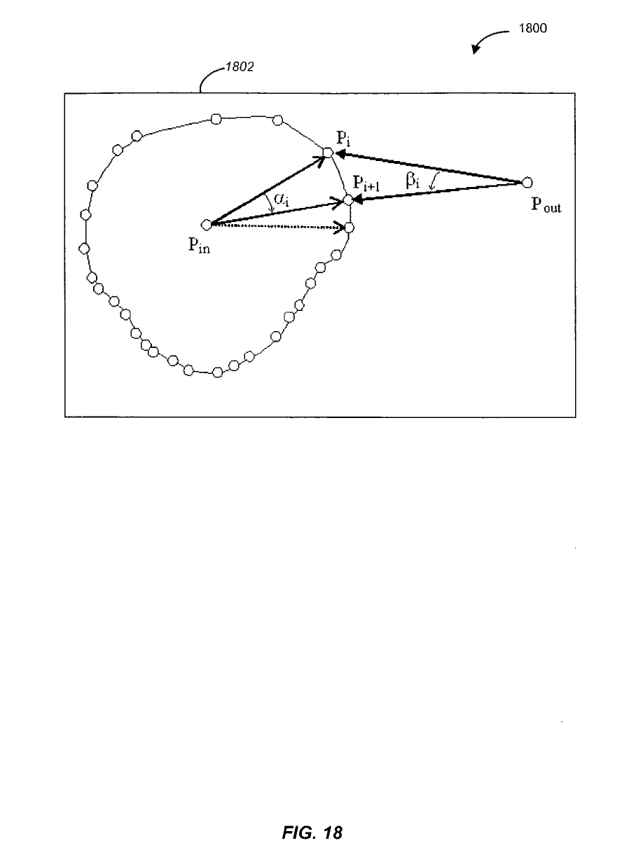

FIG. 18 is a diagram 1800 illustrating an outside point Pₒᵤₜ and an inside point Pᵢₙ with respect to contour 1802 that may be viewed as a polygon. For the inside point Pᵢₙ, the sum of the angles made between Pᵢₙ and each pair of points making up the polygon is 2π, as shown in Table 10 below.

TABLE 10
${\sum }_{i} {α}_{i} = 2 π$

For the outside point Pₒᵤₜ, the sum of the angles made between Pₒᵤₜ and each pair of points making up the polygon is 0, as shown in Table 11 below.

TABLE 11
${\sum }_{i} {β}_{i} = 0$

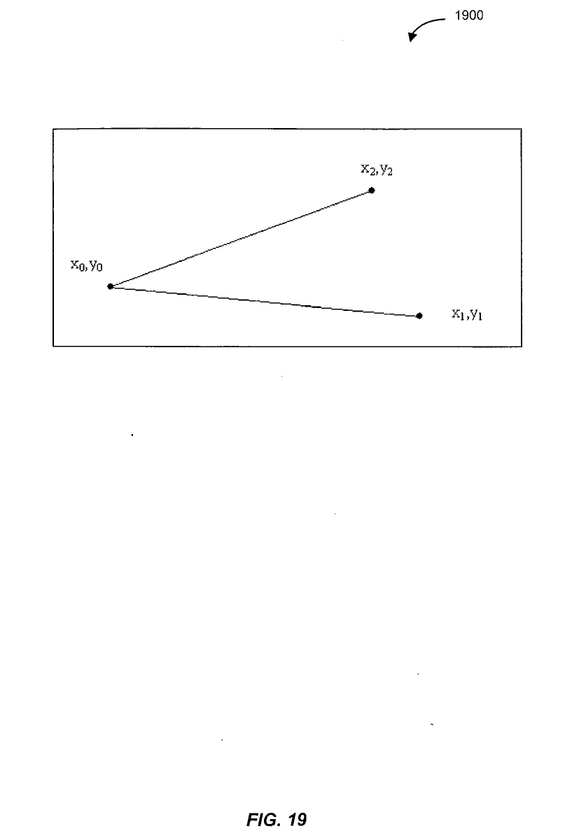

Calculating the angle between two vectors may be described with reference to a diagram 1900 in FIG. 19. Let (x₀, y₀) be a point in the center of a pixel, and let (x₁,yₗ) and x₂,y₂) be two consecutive vertices around the contour. The vectors between the pixel point and the vertex points are \vec{u} and \vec{v}. Let î and ĵ be the unit vectors within the reconstruction plane.

The angle between the vectors is then calculated using the equation as shown in Table 12 below.

TABLE 12
$θ = {tan}^{- 1} [ \frac{{u}^{->} \times {v}^{->}}{{u}^{->} • {v}^{->}} ] ,$
where dhe vectors, their dot product, and cross product are defined as follows:
\vec{u} = (x₁ − x₀)î + (y₁ − y₀)ĵ
\vec{v} = (x₂ − x₀)î + (y₂ − y₀)ĵ
\vec{u} • \vec{v} = |u| · |v|cos(θ) = xᵤxᵥ + yₓyᵥ = (x₁ − x₀) · (x₂ − x₀) + (y₁ − y₀) · (y₂ − y₀)
\vec{u} × \vec{v} = |u| · |v|sin(θ) = [xᵤ · yᵥ − xᵥ · yᵤ] \hat{k} = [(x₁ − x₀) · (y₂ − y₀) − (x₂ − x₀) · (y₁ − y₀)] \hat{k}

When the test point is inside, the summed angle is 2π, while when the test point is right on the boundary, the summed angle is π. When the test point is outside, the angle is 0.

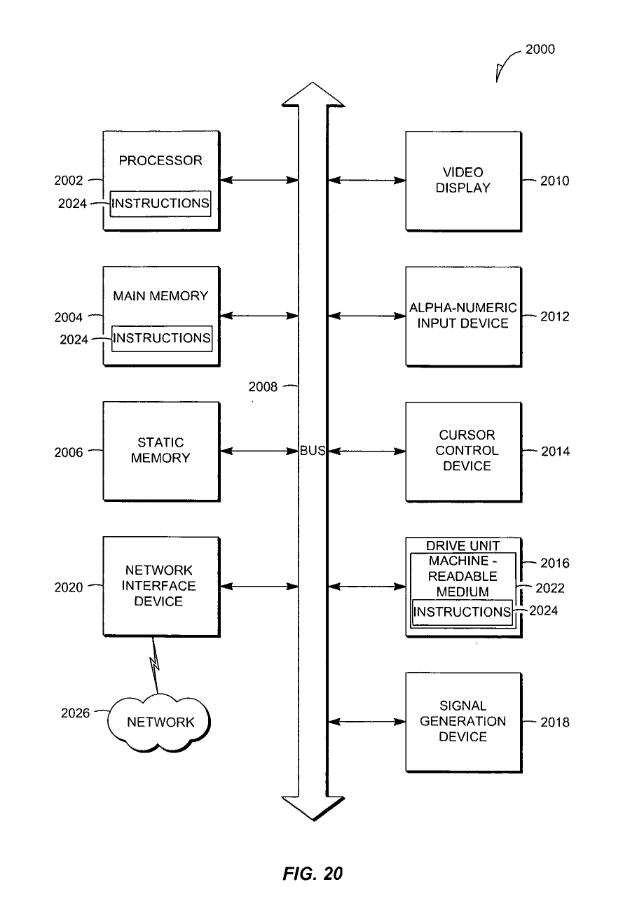

FIG. 20 shows a diagrammatic representation of a machine in the example form of a computer system 2000 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 2000 includes a processor 2002 (e.g., a central processing unit (CPU), a graphics processing unit (GPU) or both), a main memory 2004 and a static memory 2006, which communicate with each other via a bus 2008. The computer system 2000 may further include a video display unit 2010 (e.g., a liquid crystal display (LCD) or a cathode ray tube (CRT)). The computer system 2000 also includes an alpha-numeric input device 2012 (e.g., a keyboard), a user interface (UI) navigation device 2014 (e.g., a cursor control device), a disk drive unit 2016, a signal generation device 2018 (e.g., a speaker) and a network interface device 2018.

The disk drive unit 2016 includes a machine-readable medium 2022 on which is stored one or more sets of instructions and data structures (e.g., software 2024) embodying or utilized by any one or more of the methodologies or functions described herein. The software 2024 may also reside, completely or at least partially, within the main memory 2004 and/or within the processor 2002 during execution thereof by the computer system 2000, with the main memory 2004 and the processor 2002 also constituting machine-readable media.

The software 2024 may further be transmitted or received over a network 2026 via the network interface device 2018 utilizing any one of a number of well-known transfer protocols (e.g., Hyper Text Transfer Protocol (HTTP)).

While the machine-readable medium 2022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing and encoding a set of instructions for execution by the machine and that cause the machine to perform any one or more of the methodologies of embodiments of the present invention, or that is capable of storing and encoding data structures utilized by or associated with such a set of instructions. The term “machine-readable medium” shall accordingly be taken to include, but not be limited to, solid-state memories, optical and magnetic media. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware. Such embodiments of the inventive subject matter may be referred to herein, individually or collectively, by the term “invention” merely for convenience and without intending to voluntarily limit the scope of this application to any single invention or inventive concept if more than one is, in fact, disclosed.

Thus, a method and system for teaching and testing radiation oncology skills has been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A computer-implemented radiation oncology education system, the system comprising:
a portal user interface configured to provide web-based access to one or more education modules; and
an education module, from the one or more education modules, comprising:
a video component to stream a video segment demonstrating contouring of an anatomical region;
a practice component to present to a user a practice medical image and an identification of a practice region of interest in the practice medical image, create a practice user-defined contour based on input from the user and overlay the practice user-defined contour onto the practice medical image, and overlay a practice reference contour onto the practice medical image, the practice reference contour representing the practice region of interest; and
a test component to present to a user a test medical image and an identification of a test region of interest in the test medical image, create a test user-defined contour based on input from the user and overlay the test user-defined contour onto the practice medical image, and generate a test result by comparing the test user-defined contour with a test reference contour representing the test region of interest using a similarity metric.

2. The system of claim 1, wherein the practice medical image is from a practice set of images, the test medical image is from a test set of images, the practice medical image and the test medical image derived respectively from a first image conforming to Digital Imaging and Communications in Medicine (DICOM) format and a second image conforming to DICOM format.

3. The system of claim 1, wherein the video component comprises a viewing completion module to enable playing a later portion of the educational video after skipping an earlier portion of the educational video only responsive to detecting a first completed playing of the educational video during a viewing session initiated by the user.

4. The system of claim 1, wherein the practice component comprises a practice session initiator module to:
detect a request from the user to initiate a practice session; and
initiate the practice session in response to the request only responsive to detecting a first completed viewing of the educational video by the user.

5. The system of claim 1, wherein the practice component to present the practice medical image together with one or more annotations associated with the practice region of interest.

6. The system of claim 1, wherein the practice component comprises a comments module to:
receive one or more comments associated with the practice region of interest from the user; and
store the one or more comments for future access as associated with an identification of the user and with the practice region of interest,
wherein the one or more comments are associated with one or more objects from the list consisting of the practice region of interest, the practice reference contour, and the user-defined contour.

7. The system of claim 6, wherein the comments module is to:
detect a request from the user to view comments associated with the practice region of interest; access comments associated with the practice region of interest; and
present to the user the accessed comments.

8. The system of claim 1, comprising a user contour module to:
associate user-defined contours created based on input from the user; and
store the user-defined contours as associated with the identification of the user.

9. The system of claim 8, wherein the user contour module is to:
detect a request from the user to view user-defined contours;
access the user-defined contours; and
present to the user only those contours from the user-defined contours that are associated with the identification of the user.

10. The system of claim 8, wherein the user contour module is to:
detect a request to view user-defined contours;
determine that an identification associate with a requesting user is indicative of an educator's access rights; and
provide the requesting user with access to the user-defined contours.

11. A computer-implemented method for teaching and testing radiation oncology skills, the method comprising:
presenting, on a display device a portal user interface configured to provide web-based access to one or more education modules;
loading an education module, from the one or more education modules, the education module configured for teaching and testing contouring skills;
commencing streaming a video segment, the video segment demonstrating contouring of an anatomical region;
commencing an on-line practice session, the practice session comprising:
displaying, on the display device, a practice medical image and an identification of a practice region of interest in the practice medical image, creating a practice user-defined contour based on input from the user and overlay the practice user-defined contour onto the practice medical image, and
overlaying a practice reference contour onto the practice medical image, the practice reference contour representing the practice region of interest; and
commencing an on-line test session, the test session comprising:
displaying, on the display device, a test medical image and an identification of a test region of interest in the test medical image,
creating a test user-defined contour based on input from the user and overlaying the test user-defined contour onto the practice medical image, and
generating a test result by comparing the test user-defined contour with a test reference contour representing the test region of interest using a similarity metric.

12. The method of claim 11, wherein the practice medical image is from a practice set of images, the test medical image is from a test set of images, the practice medical image and the test medical image derived respectively from a first image conforming to Digital Imaging and Communications in Medicine (DICOM) format and a second image conforming to DICOM format.

13. The method of claim 11, comprising:
detecting a fast forward request from the user to move forward and skip a portion of the educational video;
detecting a first completed viewing of the educational video during a viewing session initiated by the user; and
process the fast forward request responsive to the detecting of the first completed viewing.

14. The method of claim 11, comprising:
disabling fast forward capability of a video progress bar provided by a video component of the educational module;
determining a first completed viewing of the educational video during a viewing session initiated by the user; and
enabling fast forward capability of the video progress bar.

15. The method of claim 11, wherein the practice component comprises a practice session initiator module to:
detecting a request from the user to initiate a practice session; and
initiating the practice session in response to the request only responsive to detecting a first completed viewing of the educational video by the user.

16. The method of claim 11, comprising presenting the practice medical image together with one or more annotations associated with the practice region of interest.

17. The method of claim 11, comprising:
receiving comments associated with the practice region of interest from the user; and
storing comments for future access as associated with an identification of the user and with the practice region of interest.

18. The method of claim 17, wherein the comments module is to:
detect a request from the user to view comments associated with the practice region of interest;
access comments associated with the practice region of interest; and
present to the user the accessed comments.

19. The method of claim 11, comprising a user contour module to:
associate user-defined contours created based on input from the user; and
store the user-defined contours as associated with the identification of the user;
detect a request from the user to view user-defined contours;
access the user-defined contours; and
present to the user only those contours from the user-defined contours that are associated with the identification of the user.

20. A machine-readable non-transitory medium having instruction data to cause a machine to:
present, on a display device a portal user interface configured to provide web-based access to one or more education modules;
load an education module, from the one or more education modules, the education module configured for teaching and testing contouring skills;
commence streaming a video segment, the video segment demonstrating contouring of an anatomical region;
commence an on-line practice session, the practice session comprising:
displaying, on the display device, a practice medical image and an identification of a practice region of interest in the practice medical image,
creating a practice user-defined contour based on input from the user and overlay the practice user-defined contour onto the practice medical image, and
overlaying a practice reference contour onto the practice medical image, the practice reference contour representing the practice region of interest; and
commence an on-line test session, the test session comprising:
displaying, on the display device, a test medical image and an identification of a test region of interest in the test medical image,
creating a test user-defined contour based on input from the user and overlaying the test user-defined contour onto the practice medical image, and
generating a test result by comparing the test user-defined contour with a test reference contour representing the test region of interest using a similarity metric.
